(19) United States
(12) Patent Application Publication
(10) Pub. No.: US 2024/0188542 A1
(43) Pub. Date: Jun. 13, 2024

(54) DETECTION AND PREDICTION OF LAMINITIS RISK IN EQUINES

(71) Applicant: Qatar Foundation for Education, Science and Community Development, Doha (QA)

(72) Inventors: Othmane Bouhali, Doha (QA); Ali Sheharyar, Doha (QA); Jessica Johnson, Doha (QA); Halima Bensmail, Doha (QA)

(21) Appl. No.: 18/535,842

(22) Filed: Dec. 11, 2023

Related U.S. Application Data
(60) Provisional application No. 63/431,926, filed on Dec. 12, 2022.

(51) Int. Cl. A01K 29/00

(52) U.S. Cl. CPC A01K 29/005; A01K 2227/10

(57) ABSTRACT

Detection and prediction of laminitis risk in equine may be provided by receiving, from a user, input features related to an equine subject at a laminitis risk detection model; responsive to receiving the input features, calculating a laminitis risk score for the subject; determining a laminitis prediction and a treatment suggestion for the equine subject based on the input features and the laminitis risk score; and outputting the laminitis risk score, laminitis prediction and treatment suggestion to the user.

### CROSS-REFERENCES TO RELATED APPLICATIONS

The present disclosure claims the benefit of U.S. Provisional Patent Application No. 63/431,926 entitled “SYSTEMS AND METHODS FOR THE DETECTION AND PREDICTION OF LAMINITIS RISK IN EQUINES” and filed on Dec. 12, 2022, which is incorporated herein by reference in its entirety.

### BACKGROUND

Laminitis is a debilitating and potentially life-threatening disease that affects the feet of equines and results in profound pain and suffering for the animal. The disease can lead to the shedding or complete loss of a horse's hoof capsule, which has resulted in laminitis becoming a leading cause of euthanasia in equines.

Laminitis is a complex, multifactorial disease with several risk factors, such as endocrinal disease and obesity, which usually requires a comprehensive medical examination to diagnose. For example, it has been estimated that a large majority of laminitis cases, as high as eighty-nine percent, result from endocrinopathic disease, with more than half of these cases specifically attributed to Equine Metabolic Syndrome. Additionally, some sought after breeds, such as the Arabian horse, are predisposed to Equine Metabolic Syndrome, one of the main clinical risk factors of laminitis. Given a reported frequency of laminitis as high as thirty-four percent and the economic value of sought after horse breeds, early detection of laminitis can lead to better treatment outcomes, which in turn leads to less pain and suffering for the horse and potential, significant savings for the horse owner. For example, veterinary hospitalization for treatment can cost tens of thousands of dollars.

Accordingly, a need exists for a system that effectively and efficiently determines an individual equine's risk for developing laminitis.

### SUMMARY

The present disclosure provides new and innovative systems and methods for analyzing and detecting an equine's risk for developing laminitis. The present disclosure provides for a laminitis risk detection system containing a laminitis risk detection model that predicts the likelihood of laminitis occurring in an individual horse and provides treatment strategies, all based on input features provided by a user.

A laminitis risk detection system may include a memory and a processor in communication with the memory, configured to execute a laminitis risk detection model, which receives input features from a user to calculate a laminitis risk score. The laminitis risk detection model then uses the laminitis risk score to determine a laminitis prediction and a treatment suggestion. The laminitis score, laminitis prediction, and treatment suggestion are output to the user for use in deciding a treatment path for the individual, assessed equine.

Example embodiments of the present disclosure may include a laminitis risk detection system designed for use in the field by horse owners, such as through a mobile application accessed on a smartphone. Further example embodiments of the present disclosure may include a laminitis risk detection system designed for use in clinical settings by veterinary professionals that may display additional medical information relevant to the diagnosis or treatment of the horse being assessed and additional clinical input features.

Additional features and advantages of the disclosed method and system are described in, and will be apparent from, the following Detailed Description and the Figures. The features and advantages described herein are not all-inclusive and, in particular, many additional features and advantages will be apparent to one of ordinary skill in the art in view of the figures and description. Moreover, it should be noted that the language used in the specification has been principally selected for readability and instructional purposes, and not to limit the scope of the inventive subject matter.

### BRIEF DESCRIPTION OF THE DRAWINGS

FIG. 1 illustrates an example laminitis risk detection system, according to embodiments of the present disclosure.

FIG. 2 illustrates an example laminitis risk detection system, according to embodiments of the present disclosure.

FIG. 3 is a flowchart illustrating an example method for detecting and predicting laminitis in equines, according to embodiments of the present disclosure.

### DETAILED DESCRIPTION

The present disclosure provides new and innovative systems and methods for detecting and predicting an equine's risk for developing laminitis. Although generally discussed in relation to an equine subject of a horse, the present disclosure contemplates that other equine individuals may benefit from the use of the present disclosure, including, but not limited to ponies, mules, donkeys, and zebras. Additionally, other hooved mammals may benefit for the use of the present disclosure, and the use with such mammals is contemplated by the present disclosure.

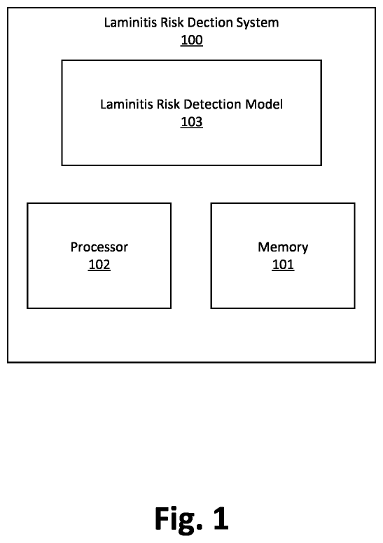

FIG. 1 illustrates a laminitis risk detection system 100, according to embodiments of the present disclosure. An example laminitis risk detection system 100 of the present disclosure may include a memory 101 and a processor 102 in communication with the memory 101 and configured to execute a laminitis risk detection model 103. The memory 101 is an example of a non-transitory computer readable storage medium that stores instructions that, when executed by the processor 102, perform the various operations discussed herein.

A laminitis risk detection model 103 may receive input features from a user deploying the system to detect and predict an individual horse's risk for developing laminitis. These input features may vary based on the user of the system. For example, an individual horse owner may input morphological features, such as height, weight, breed, girth diameter, foot diameter, body condition score, or other features that are easily obtainable by a horse owner (e.g., morphological data). Also, the laminitis risk detection model 103 may provide the user with instructions on how to accurately measure the required input features.

Additionally or alternatively, a veterinarian or clinician may input clinical features determined through additional clinical examinations/observations (e.g., clinical data), such as factors pertaining to specific endocrinopathies like Equine Metabolic Syndrome, into the laminitis risk detection model 103. In an example embodiment of a laminitis risk detection system 100 for use by a veterinarian or clinician, a user may also input genomic, transcriptomic, and other information to identify prognostic factors to point to helping in the recovery of an individual horse from laminitis. Additionally, the input features may be a combination of clinical and morphological features.

Responsive to the input features, the laminitis risk detection model 103 may calculate a laminitis risk score. In determining the laminitis risk score, the laminitis risk detection model 103 may implement artificial intelligence algorithms to evaluate the input features in a manner that allows for the prediction of the development of laminitis. The laminitis risk score may be represented as a single value that can be used to track an individual horse's risk of developing laminitis over time.

Based on the calculated laminitis risk score, the laminitis risk detection model 103 may determine a laminitis prediction. The laminitis prediction represents the predicted occurrence of laminitis in an individual horse. For example, the laminitis risk detection model 103 may predict that a horse is at high risk for developing laminitis if that horse receives a laminitis risk score that exceeds a certain threshold.

Also, based on the calculated laminitis risk score, the laminitis risk detection model 103 may determine a treatment suggestion. This treatment suggestion may include providing guidance on how an individual horse may continue to keep from developing risk factors that lead to laminitis. Additionally, based on the laminitis risk score, the laminitis risk detection model 103 may determine a treatment suggestion that recommends the hospitalization of the horse. For example, the laminitis risk detection model 103 may determine that an individual with a laminitis risk score within a given range requires hospitalization and report this requirement as the treatment suggestion.

The laminitis risk detection model 103 may output the calculated laminitis risk score and treatment suggestion to the user. For example, the laminitis risk detection model 103 may display the laminitis risk score and treatment suggestion as a report on a clinical display device. Alternatively, the laminitis risk detection system 100 may be configured for use in the field by individual horse owners, and so the laminitis risk detection model 103 may display the laminitis risk score and treatment suggestion in a mobile application on a horse owner's personal electronic device, such as a smartphone.

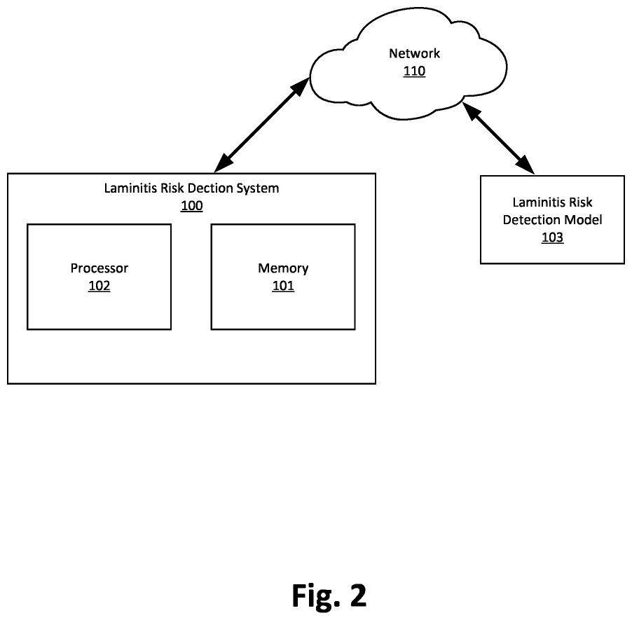

FIG. 2 illustrates an example laminitis risk detection system 100, according to embodiments of the present disclosure in which the laminitis risk detection system 100 is accessed via a network 110. In an example embodiment, the laminitis risk detection system 100 may be implemented as a mobile application on a personal electronic device, such as a smartphone. The mobile application may include a laminitis risk detection system interface by which an individual horse owner provides the laminitis risk detection system 100 with input features related to an individual horse. The laminitis risk detection system 100 may transmit the input features to a laminitis risk detection model 103 over a network 110, for example, in embodiments in which the laminitis risk detection model is hosted on a cloud server. Accordingly, the laminitis risk detection model 103 may be stored in a memory local to or remote to the laminitis risk detection system 100.

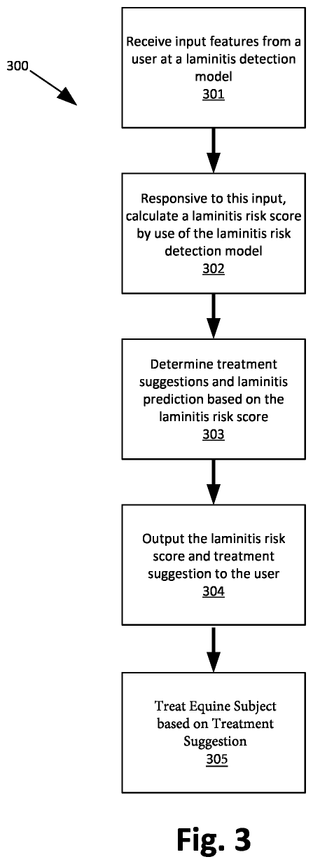

FIG. 3 is a flowchart illustrating an example method 300 for detecting and predicting laminitis in equines, according to embodiments of the present disclosure. Although the example method 300 is described with reference to the flowchart illustrated in FIG. 3, the present disclosure contemplates that many other methods of performing the acts associated with the method 300 may be used. For example, the order of some of the blocks may be changed, certain blocks may be combined with other blocks, blocks may be repeated, and some of the blocks described are optional. The method 300 may be performed by processing logic that may comprise hardware (circuitry, dedicated logic, etc.), software, or a combination of both.

In an example embodiment of the present disclosure, a method 300 for the detection and prediction of laminitis may include receiving input features from a user at a laminitis risk detection model 103 (block 301). Responsive to receiving the input features, a laminitis risk detection model 103 calculates a laminitis risk score (block 302). For example, the laminitis risk score may be a single value or multivariate piece of data that represents an individual horse's risk for developing laminitis.

The method 300 may include determining a laminitis prediction and a treatment suggestion based on the laminitis risk score calculated for an individual horse (block 303). For example, a veterinarian may input a combination of clinical factors that indicate that the individual horse suffers from Equine Metabolic Syndrome and morphological features that indicate that the individual is obese based on physical measurements, such as height, weight, breed, and age. The laminitis risk detection model 103 may calculate a laminitis risk score that indicates a high likelihood for the development of laminitis. Therefore, the laminitis risk detection model 103 may determine that the individual horse has an 80% likelihood of developing laminitis (e.g., a laminitis prediction) and that the horse requires hospitalization and dietary intervention.

The method 300 for detecting and predicting the occurrence of laminitis may include outputting one or more of the laminitis risk score, laminitis prediction, and treatment suggestion to the user (block 304). For example, a farmer who owns a horse may input morphological features related to the horse at a laminitis risk detection system deployed as smartphone application, which leverages the laminitis risk detection model 103 to calculate a laminitis risk score. The laminitis risk detection model 103 may then display the determined risk score, laminitis prediction, and treatment suggestion on the screen of the smartphone running the application.

The method 300 for detecting and predicting the occurrence of laminitis may include treating the equine subject either reactively for laminitis or prophylactically against laminitis based on the treatment suggestion (block 305).

Further example embodiments of the present disclosure may include a laminitis risk detection system designed for use in the field by horse owners, such as through a mobile application accessed on a smartphone. Further example embodiments of the present disclosure may include a laminitis risk detection system designed for use in clinical settings by veterinary professionals that may display additional medical information relevant to the diagnosis or treatment of the horse being assessed and additional clinical input features. In this example, the display of the laminitis score may include tabs containing additional clinical information that may include the following: interpretation of diagnostic imaging (including radiography of the feet, and potentially advanced imaging modalities, e.g. computed tomography (CT), Magnetic Resonant Imaging (MRI), Positron Emission Tomography (PET)), hematology and biochemistry blood results, as well as results pertaining to specific endocrinopathies, such as Pars Pituitary Intermedia Dysfunction (or “Cushings Disease”), e.g. Adrenocorticotropic hormone (ACTH) levels, and Equine Metabolic Syndrome, e.g. basal glucose & insulin levels, as well as oral glucose tolerance test result and additional clinical pathology data entries.

Certain terms are used throughout the description and claims to refer to particular features or components. As one skilled in the art will appreciate, different persons may refer to the same feature or component by different names. This document does not intend to distinguish between components or features that differ in name but not function.

As used herein, the term “optimize” and variations thereof, is used in a sense understood by data scientists to refer to actions taken for continual improvement of a system relative to a goal. An optimized value will be understood to represent “near-best” value for a given reward framework, which may oscillate around a local maximum or a global maximum for a “best” value or set of values, which may change as the goal changes or as input conditions change. Accordingly, an optimal solution for a first goal at a given time may be suboptimal for a second goal at that time or suboptimal for the first goal at a later time.

As used herein, “about,” “approximately” and “substantially” are understood to refer to numbers in a range of the referenced number, for example the range of −10% to +10% of the referenced number, preferably −5% to +5% of the referenced number, more preferably −1% to +1% of the referenced number, most preferably −0.1% to +0.1% of the referenced number.

Furthermore, all numerical ranges herein should be understood to include all integers, whole numbers, or fractions, within the range. Moreover, these numerical ranges should be construed as providing support for a claim directed to any number or subset of numbers in that range. For example, a disclosure of from 1 to 10 should be construed as supporting a range of from 1 to 8, from 3 to 7, from 1 to 9, from 3.6 to 4.6, from 3.5 to 9.9, and so forth.

As used in the present disclosure, a phrase referring to “at least one of” a list of items refers to any set of those items, including sets with a single member, and every potential combination thereof. For example, when referencing “at least one of A, B, or C” or “at least one of A, B, and C”, the phrase is intended to cover the sets of: A, B, C, A-B, B-C, and A-B-C, where the sets may include one or multiple instances of a given member (e.g., A-A, A-A-A, A-A-B, A-A-B-B-C-C-C, etc.) and any ordering thereof. For avoidance of doubt, the phrase “at least one of A, B, and C” shall not be interpreted to mean “at least one of A, at least one of B, and at least one of C”.

As used in the present disclosure, the term “determining” encompasses a variety of actions that may include calculating, computing, processing, deriving, investigating, looking up (e.g., via a table, database, or other data structure), ascertaining, receiving (e.g., receiving information), accessing (e.g., accessing data in a memory), retrieving, resolving, selecting, choosing, establishing, and the like.

Without further elaboration, it is believed that one skilled in the art can use the preceding description to use the claimed inventions to their fullest extent. The examples and aspects disclosed herein are to be construed as merely illustrative and not a limitation of the scope of the present disclosure in any way. It will be apparent to those having skill in the art that changes may be made to the details of the above-described examples without departing from the underlying principles discussed. In other words, various modifications and improvements of the examples specifically disclosed in the description above are within the scope of the appended claims. For instance, any suitable combination of features of the various examples described is contemplated.

Within the claims, reference to an element in the singular is not intended to mean “one and only one” unless specifically stated as such, but rather as “one or more” or “at least one”. Unless specifically stated otherwise, the term “some” refers to one or more. No claim element is to be construed under the provision of 35 U.S.C. § 112(f) unless the element is expressly recited using the phrase “means for” or “step for”. All structural and functional equivalents to the elements of the various embodiments described in the present disclosure that are known or come later to be known to those of ordinary skill in the relevant art are expressly incorporated herein by reference and are intended to be encompassed by the claims. Moreover, nothing disclosed in the present disclosure is intended to be dedicated to the public regardless of whether such disclosure is explicitly recited in the claims.

The invention is claimed as follows:

1. A laminitis risk detection system, comprising:
a memory; and
a processor in communication with the memory, the processor configured to:
execute a laminitis risk detection model;
receive, from a user, input features related to an equine subject into the laminitis risk detection model;
responsive to receiving the input features, calculate a laminitis risk score for the equine subject;
determining a treatment suggestion and a laminitis prediction for the equine subject based on the input features and laminitis risk score; and
output the laminitis risk score, laminitis prediction, and treatment suggestion to the user.

2. The system of claim 1, wherein the input features include morphological data related to the equine subject.

3. The system of claim 1, wherein the input features include clinical data related to the equine subject.

4. The system of claim 1, wherein the laminitis risk detection model is stored in memory.

5. The system of claim 1, wherein the laminitis risk detection model is accessed over a network.

6. The system of claim 1, wherein the equine subject is treated for laminitis or prophylactically treated for laminitis based on the treatment suggestion.

7. A method for laminitis risk detection, comprising:
receiving, from a user, input features related to an equine subject at a laminitis risk detection model;
responsive to receiving the input features, calculating a laminitis risk score for the equine subject;
determining a laminitis prediction and a treatment suggestion for the equine subject based on the input features and the laminitis risk score; and
outputting the laminitis risk score, laminitis prediction and treatment suggestion to the user.

8. The method of claim 7, further comprising accessing a laminitis risk detection model over a network.

9. The method of claim 7, further comprising accessing a laminitis risk detection model stored in memory.

10. The method of claim 7, wherein the input features include morphological data related to the equine subject.

11. The method of claim 7, wherein the input features include clinical data related to the equine subject.

12. The method of claim 7, further comprising treating the equine subject for laminitis based on the treatment suggestion.

13. The method of claim 7, further comprising treating the equine subject prophylactically against laminitis based on the treatment suggestion.

14. A non-transitory computer readable medium storing instructions that, when executed by a processor, performs operations comprising:
receiving, from a user, input features related to an equine subject at a laminitis risk detection model;
responsive to receiving the input features, calculating a laminitis risk score for the equine subject;
determining a laminitis prediction and a treatment suggestion for the equine subject based on the input features and the laminitis risk score; and
outputting the laminitis risk score, laminitis prediction and treatment suggestion to the user.

15. The medium of claim 14, the operations further comprising accessing a laminitis risk detection model over a network.

16. The medium of claim 14, the operations further comprising accessing a laminitis risk detection model stored in memory.

17. The medium of claim 14, wherein the input features include morphological data related to the equine subject.

18. The medium of claim 14, wherein the input features include clinical data related to the equine subject.

19. The medium of claim 14, further comprising treating the equine subject for laminitis based on the treatment suggestion.

20. The medium of claim 14, further comprising treating the equine subject prophylactically against laminitis based on the treatment suggestion.
